(19) United States
(12) Patent Application Publication
(10) Pub. No.: US 2026/0099759 A1
(43) Pub. Date: Apr. 9, 2026

(54) METHODS AND APPARATUS TO PROCESS TRAINING DATA FOR AN AI-BASED MODEL

(71) Applicant: McAfee, LLC, San Jose, CA (US)

(72) Inventor: Niall Fitzgerald, Cork (IE)

(21) Appl. No.: 18/907,233

(22) Filed: Oct. 4, 2024

(51) Int. Cl. G06N 20/00

(52) U.S. Cl. CPC G06N 20/00

(57) ABSTRACT

An example apparatus includes interface circuitry to obtain data; samples to train an AI-based model; machine readable instructions; and at least one programmable circuit to at least one of instantiate or execute the machine readable instructions to: transform the data samples into features; generate hash signatures for corresponding ones of the features; group the features into clusters based on the hash signatures; generate a filtered data set by filtering out features within a cluster of features having more than a threshold number of features; and train the AI-based model based on the filtered data set.

### BACKGROUND

Malware (e.g., viruses, worms, trojans, ransomware) is malicious software that is disseminated by attackers to launch a wide range of security attacks, such as stealing user's private information, hijacking devices remotely, infiltrating a user's online account credentials, etc. The introduction of malware to a computing system may cause serious damage and significant financial loss to computer and/or Internet users.

### BRIEF DESCRIPTION OF THE DRAWINGS

FIG. 1 is an example environment including model training circuitry constructed in accordance with teachings of this disclosure.

FIG. 2 is a block diagram of an example implementation of the training data filtering circuitry of FIG. 1.

FIG. 3 is a flowchart representative of example machine-readable instructions and/or operations that may be executed, instantiated, and/or performed by programmable circuitry to implement the training data filtering circuitry and the AI-based model training circuitry of FIGS. 1 and/or 2.

FIG. 4 is a flowchart representative of example machine-readable instructions and/or operations that may be executed, instantiated, and/or performed by programmable circuitry to implement the training data filtering circuitry of FIG. 2.

FIG. 5 is a graph representative of cluster statistics that can be a generated by the training data filtering circuitry of FIG. 2.

FIG. 6 is a block diagram of an example processor platform including programmable circuitry structured to execute, instantiate, and/or perform the computer readable instructions and/or perform the example operations of FIGS. 3-4 to implement at least one of the training data filtering circuitry or the AI-based model training circuitry of FIG. 1.

FIG. 7 is a block diagram of an example implementation of the programmable circuitry of FIG. 6.

FIG. 8 is a block diagram of another example implementation of the programmable circuitry of FIG. 6.

FIG. 9 is a block diagram of an example software/firmware/instructions distribution platform (e.g., one or more servers) to distribute software, instructions, and/or firmware (e.g., corresponding to the example machine-readable instructions of FIGS. 3-4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

An artificial intelligent (AI) model (e.g., a machine learning (ML), deep learning (DL), and/or other AI-based approach) may be utilized to identify malware. Such malware detection may be performed using a supervised ML and/or other unsupervised ML models and deep learning (DL) algorithms such as, for example, a convolutional neural network (CNN), a recurrent neural network (RNN), a machine learning algorithm etc., configured to be trained using input data with known (e.g., an expected classification of the model) classifications. For example, the input data may be files that are known to be malware/malicious/dirty or non-malware/benign/clean. The AI model is trained using the input data to be able to classify whether a file is malware or not.

Implementing AI models may include facilitating a training stage to train the AI-based model using ground truth data (e.g., training data correctly labeled with a particular classification and/or unlabeled training data). During training, a portion of the training data may be used to tune the AI-based model to output a desired result based on an input. For example, the AI-based model obtains data that includes inputs and pre-classified outputs and the AI-based model can tune weights based on patterns of the data so that the AI-based model outputs the desired output based on the input data.

Additionally, the AI-based model may use a separate portion of the training data to test the model to identify the accuracy of the AI-based model. If the accuracy is below a threshold, additional training data can be used to further tune the AI-based model.

To generate a robust AI-based model, it may be desirable to use a large amount of training data. However, too much training data may result in excess resources and/or time to train an AI-based model. Accordingly, training data may be filtered by random sampling/selecting training data from a database of training data to train the AI-based model. However, random sampling of data in a large database may result in underrepresentation/undersampling and/or overrepresentation/oversampling of particular characteristics of files in the training data. For example, training data corresponding to one type of malware may include 1000 files in a database that includes millions of files. Accordingly, randomly filtering the database likely results in an underrepresentation of the type of malware that includes 1000 files. Thus, the AI-based model likely does a poor job classifying such malware. For example, overrepresentation of malware can result in large label imbalance due to overrepresentation. To achieve high efficacy and performance, AI-based models should be trained with an adequate representation of benign files/samples and malicious files/samples that are well represented across areas of a feature space.

For a database with a large amount of data, it may be difficult to determine details related to the feature space (e.g., to identify which type of data is overrepresented, underrepresented, how much of a particular data type or labeled vs unlabeled, the amount of data that corresponds to different classifications (e.g., malicious vs. benign), etc.). Examples disclosed herein identify cluster sub-spaces of the entire feature space represented by the training data. Examples disclosed herein stratify (e.g., cluster) the training dataset by factors such as labels and/or other meta-information (e.g., geo-location, filetype, threat-family, etc.). Examples disclosed herein process both labeled and unlabeled training data to group similar data into clusters. Examples disclosed herein further filter the training data based on the clusters to reduce the amount of training data to train an AI-based model while limiting and/or eliminating oversampling and/or undersampling. Examples disclosed herein process the training data using a hashing signature technique (e.g., a Minhash signature generation model or algorithm) and cluster data using a clustering technique (e.g., a k-mode clustering model or algorithm). After processing and/or grouping training data, examples disclosed herein can effectively and/or efficiently filter the training data to limit and/or eliminate oversample/undersampling. In this manner, examples disclosed herein can increase the effectiveness of an AI-based model using less resources than traditional techniques. Although examples disclosed herein are described in conjunction with AI-based models that classify files as malware or non-malware, examples disclosed herein can be described in conjunction with any type of AI-based model.

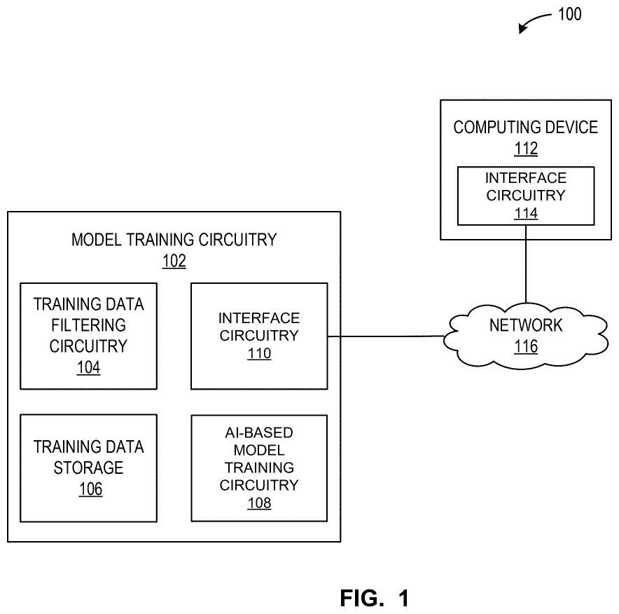

FIG. 1 is an example environment 100 that includes example model training circuitry 102 to process and/or filter training data. The model training circuitry 102 includes example training data filtering circuitry 104, example training data storage 106, example AI-based model training circuitry 108, example interface circuitry 110. The environment 100 further includes an example computing device 112, example interface circuitry 114, and an example network 116. Although the training data filtering circuitry 104, the training data storage 106, and the AI-based model raining circuitry 108 are implemented in a single device, the training data filtering circuitry 104, the training data storage 106, and/or the AI-based model raining circuitry 108 may be implemented in one or more different devices (e.g., connected via the network 116).

The model training circuitry 102 of FIG. 1 may be a computing device of any type such as a server. The model training circuitry 102 obtains files from computing devices (e.g., including the computing device 112). For example, the computing device 112 may send a file that has been identified as malicious that the model training circuitry 102 can use to train and/or retrain an AI-based model that identifies malicious files.

The training data filtering circuitry 104 of FIG. 1 obtains training data (e.g., feature vectors) from the training data storage 106. The training data filtering circuitry 104 converts the feature vectors into an inference-ready state using a transformation technique. The inference ready state is a state of the data needed to be input to an AI-based model. Additionally, the training data filtering circuitry 104 generates one or more hash signatures for each of the features from the training data storage 106. In some examples, the training data filtering circuitry 104 uses a Minhash signature algorithm to generate one or more hash signatures for each of the samples. The Minhash signature algorithm estimates the similarity between the input values. In this manner, if the output Minhash signature(s) of two input features are similar, then there is a high probability that the two features are similar.

After one or more Minhash signatures are generated for each of the input features, the training data filtering circuitry 104 of FIG. 1 performs a clustering model (e.g., a k-modes clustering model) to group similar features together based on the Minhash signatures. For example, if 1,000 features have similar Minhash signature(s), the training data filtering circuitry 104 can generate a cluster/group number for the features to identify that the features are similar. The training data filtering circuitry 104 labels each feature with the corresponding meta-data (e.g., classification label, geo location, gender, timestamp and/or any other information associated with the feature), the cluster number, and whether the feature is labeled or not. The training data filtering circuitry 104 can then process the features to develop a representation of the training data and/or filter the training data to provide a smaller, effective, and/or optimal training set to train an AI-based model, as further described below. For example, the training data filter circuitry 104 can filter the features to decrease the amount of time and resources to train an AI-based model while ensuring that particular feature types and/or classification types are not over-represented or under-represented.

The AI-based model training circuitry 108 of FIG. 1 trains an AI-based model using filtered training data. As described above, the training data filtering circuitry 104 accesses the training data storage 106 and filters the training data storage 106 to decrease the amount of storage while also ensuring that particular feature types are not over-represented or under-represented and/or that the balance of classification is sufficient. In some examples, the AI-based model uses the filtered training data to train an AI-based model to classify files as malicious or benign. The AI-based model training circuitry 108 may use one or more portions of the training data to train the AI-based model and another one or more portions of the training data to test accuracy of the AI-based model. After training, the AI-based model training circuitry 108 causes the AI-based model to be deployed for use (e.g., to the computing device 112).

The interface circuitry 110 of FIG. 1 can obtain or transmit data to/from other computing devices (e.g., including the computing device 112) via the network 116. Additionally, the interface circuitry 110 can obtain a file from the computing device 112 that can be added to the training data storage 106 (e.g., for training or retraining purposes). Additionally, the interface circuitry 110 can deploy trained AI-based models (e.g., information corresponding to the weights, thresholds, and/or structure of an AI-based model) to a computing device (e.g., the computing device 112). In this manner, the computing device 112 can implement the trained AI-based model to identify malicious files, for example.

The computing device 112 of FIG. 1 is a device that obtains and/or executes files that may be malicious or benign. In some examples, the computing device 112 may transmit an indication that a file is malicious or non-malicious to the model training circuitry 102. In such examples, if the user permits, the computing device 112 can transmit an obtained file to the model training circuitry 102 for further analysis and/or to be included in the training data storage 106. Additionally, the computing device 112 can implement a trained AI-based model to process files that have been obtained (e.g., downloaded, streamed, etc.) to determine if the files are malicious or non-malicious. The computing device 112 includes the interface circuitry 114 to obtain and/or transmit data to/from the model training circuitry 102.

The example network 116 of FIG. 1 is a system of interconnected systems exchanging data. The example network 116 may be implemented using any type of public or private network such as, but not limited to, the Internet, a telephone network, a cellular network, a local area network (LAN), a wide area network (WAN), mobile broadband, a 3GPP network, a cable network, and/or a wireless network. To enable communication via the network 116, the model training circuitry 102 and/or the computing device 112 may include a communication interface that enables a connection to an Ethernet, a digital subscriber line (DSL), Fiber Optic connections, Satellite Internet, a telephone line, a coaxial cable, or any wireless connection, etc. In some examples, the model training circuitry 102 and/or the computing device 112 are connected via the example network 116.

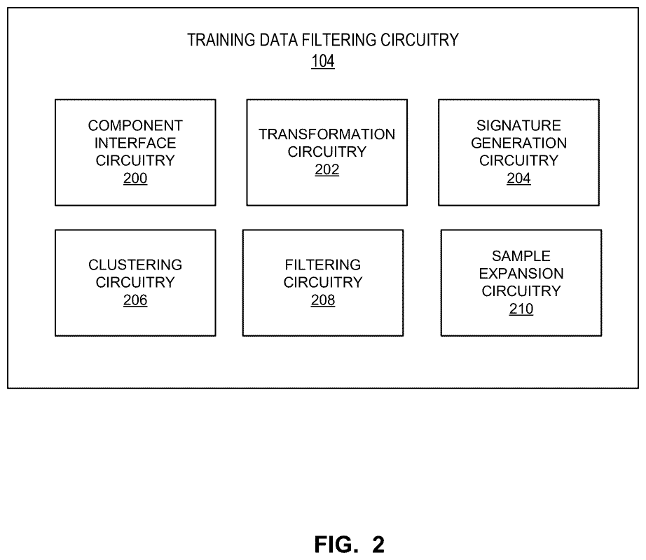

FIG. 2 is an example block diagram implementation of the training data filtering circuitry 104. The training data filtering circuitry 104 includes the component interface 200, the transformation circuitry 202, the signature generation circuitry 204, the clustering circuitry 206, the filtering circuitry 208, and the sample expansion circuitry 210.

The component interface 200 of FIG. 2 interfaces with the other components of the model training circuitry 102. For example, the component interface 200 can access training data from the data storage 106. The training data may include labels and/or other metadata corresponding to the training data. Additionally, the training data filtering circuitry 104 can output filtered training data to the AI-based model training circuitry 108 to train an AI-based model.

The transformation circuitry 202 of FIG. 2 transforms the samples (e.g., data samples, features, emails, files, executables, etc.) from the data storage 106 into vectors in an inference-ready state. For example, the samples may not be in a state suitable for an AI-based model to be trained. Accordingly, the transformation circuitry 202 may adjust the samples into an inference-ready stage by cleaning, combining, tokenizing, and/or vectorizing the samples. For example, the transformation circuitry 202 can convert text, a file, etc. into numerical values that the AI-based model can be trained with.

The signature generation circuitry 204 of FIG. 2 generates at least one hash signature for each of the transformed samples. The number of hash signatures (e.g., also referred to as hash tables) for each transformed sample may be based on user and/or manufacturer preferences. The higher the number of hash signatures per transformed sample, the more accurate the mapping from the original data is, at the cost of resources. The signature generation circuitry 204 generates hash signatures using a Minhash signature generation technique. Minhash signature generation is scalable to be able to process larges amount of training data. As described above, the hash table outputs are a function of the input sample. Accordingly, if two hash signature outputs of different input samples are similar (e.g., close in value), then there is a high probability that the input samples are similar. The below Table 1 illustrates an example of three hash signatures/tables. However, as described above, there may be any number of hash signature/tables.

TABLE 1
Example Minhash signatures

| Sample No. | Hash table 1 | Hash table 2 | Hash table 3 |
|---|---|---|---|
| 1 | 21225 | 16010 | 17614 |
| 2 | 20240 | 33388 | 30040 |
| 3 | 22825 | 49767 | 43661 |
| 4 | 45364 | 10873 | 48314 |
| 5 | 18368 | 15098 | 47645 |
| . . . | . . . | . . . | . . . |

The clustering circuitry 206 of FIG. 2 groups the samples into a cluster based on the hash signatures of the samples. Additionally, the clustering circuitry 206 can determine statistics related to the samples in the clusters and/or the metadata and labels of the samples in the clusters. To generate the clusters, the clustering circuitry 206 can perform a k-modes clustering technique or protocol. For example, the clustering circuitry 206 can group similar samples into clusters based on their categorical attributes. The clustering circuitry 206 can pick K observations at random and uses the k observations as leaders/clusters. The value of K may be based on user and/or manufacturer preferences. A lower K will result in more generalized larger clusters that are include data that may be less similar than a higher K and a higher K will result in more specific smaller clusters. The clustering circuitry 206 can calculate the dissimilarities and assign each observation to its closest cluster and then define new modes for the clusters. The clustering circuitry 206 can release the calculation of the dissimilarities and the defining of the new modes until re-assignments are complete. After the clustering is complete, the clustering circuitry 206 can determine statistics about the clusters. The statistics may include the number of samples in a cluster, the percentage of samples that correspond to different classifications (e.g., if labeled), the percentage of samples in the cluster that are or are not labeled, etc. The below Table 2 illustrates an example of statistics related to clusters that the cluster circuitry 206 can generate. However, as described above, the statistics may include additional or alternative information.

TABLE 2
Clustering statistics

| Cluster Number | % malicious | % labeled |
|---|---|---|
| 38 | 75% | 0.1% |
| 19 | 74% | 18.4% |
| 43 | 72.4% | 33.4% |
| 24 | 65.0% | 0.2% |

The filtering circuitry 208 of FIG. 2 filters the training data based on the clusters and/or statistics generated by the clustering circuitry 206. For example, the filtering circuitry 208 can ensure that samples are chosen from each cluster and/or that over or under representation is reduced and/or eliminated based on the statistics of the clusters. For example, if the minimum number of samples in a cluster is 1,000, the filtering circuitry 208 may use no more than some percentage (e.g., 10% or other percentage defined by a user or manufacturer) more than the minimum number of samples in any cluster and filter out the rest of the features, thereby ensuring similar representation of samples across clusters. Additionally, the filtering circuitry 208 may filter out samples based on a threshold number or range of classifications. For example, a user may want to train a model with 40-60% malicious files and 60-40% non-malicious files. In such an example, the filtering circuitry 208 may select samples within a cluster to ensure that the entire filtered training dataset matches the threshold range of classifications. There are many different ways to filter the training data based on the information generated by the clustering circuitry 206. The filtering circuitry 208 protocol may be based on user preferences, manufacture preferences, the field of classification, the AI-based model, the training data, etc.

The sample expansion circuitry 210 of FIG. 2 can perform one or more actions based on the statistics generated by the clustering circuitry 206. For example, if the amount of training data in a particular cluster is below a threshold amount, the sample expansion circuitry 210 can transmit a request to the computing device 112 to transmit a file that corresponds to the underrepresented samples. In this manner, the computing device may be able to provide a file and/or an executable, if available, that can be analyzed to provide more data to be included in the training dataset. In some examples, the sample expansion circuitry 210 can trigger the labelling of one or more unlabeled samples based on the percentage of unlabeled samples within a cluster. For example, if a cluster has less than a threshold amount or percentage of labeled samples, the sample expansion circuitry 210 may transmit the samples to a user and/or device (e.g., an AI based model trained to label unlabeled samples) to generate labels for the unlabeled data.

While an example manner of implementing the training data filtering circuitry 104 and/or the AI-based model training circuitry 108 of FIG. 1 is illustrated in FIGS. 1 and/or 2, one or more of the elements, processes, and/or devices illustrated in FIGS. 1 and/or 2 may be combined, divided, re-arranged, omitted, eliminated, and/or implemented in any other way. Further, the component interface circuitry 200, the transformation circuitry 202, the signature generation circuitry 204, the clustering circuitry 206, the filtering circuitry 208, the sample expansion circuitry 210, and/or, more generally, the training data filtering circuitry 104 and/or the AI-based model training circuitry 108 of FIGS. 1 and/or 2, may be implemented by hardware alone or by hardware in combination with software and/or firmware. Thus, for example, any of the component interface circuitry 200, the transformation circuitry 202, the signature generation circuitry 204, the clustering circuitry 206, the filtering circuitry 208, the sample expansion circuitry 210, and/or, more generally, the example the training data filtering circuitry 104 and/or the AI-based model training circuitry 108, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example the training data filtering circuitry 104 and/or the AI-based model training circuitry 108 of FIGS. 1 and/or 2 may include one or more elements, processes, and/or devices in addition to, or instead of, those illustrated in FIGS. 1 and/or 2, and/or may include more than one of any or all of the illustrated elements, processes and devices.

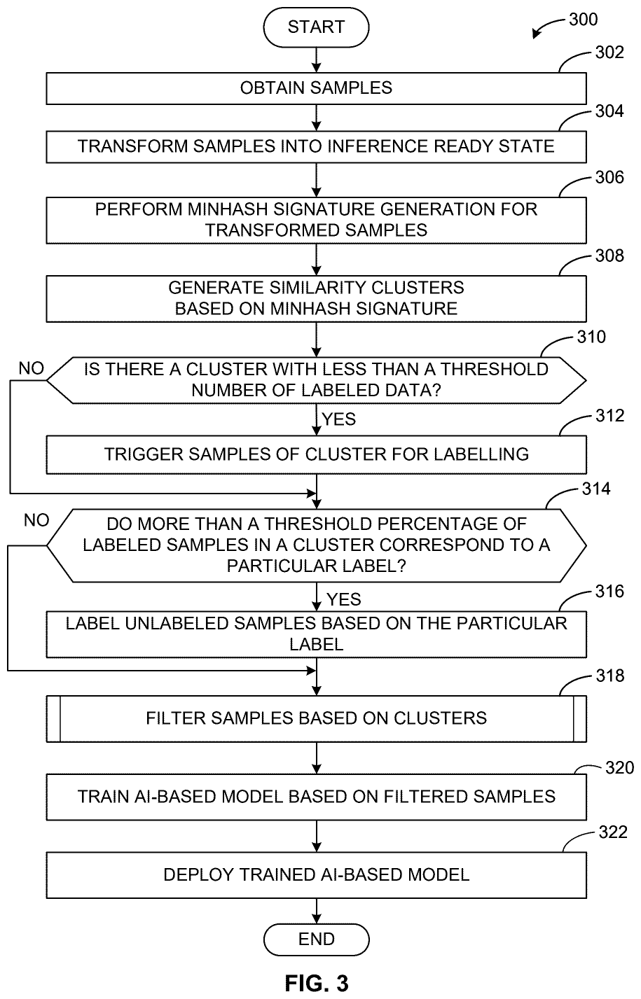

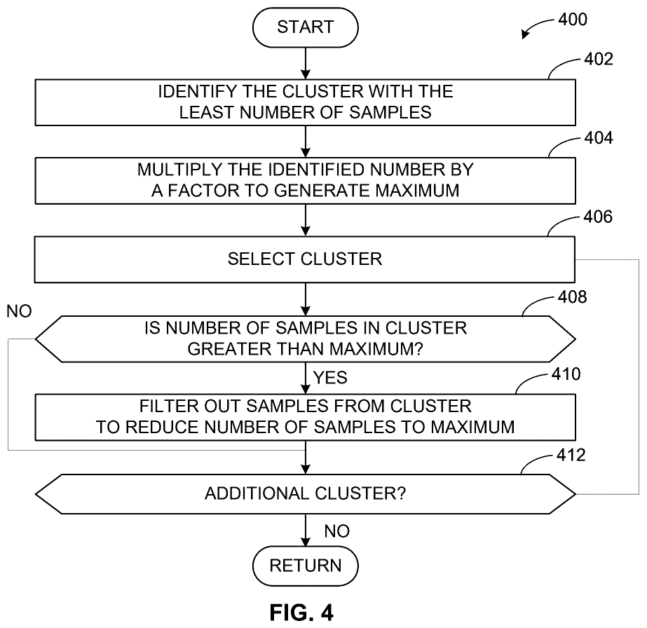

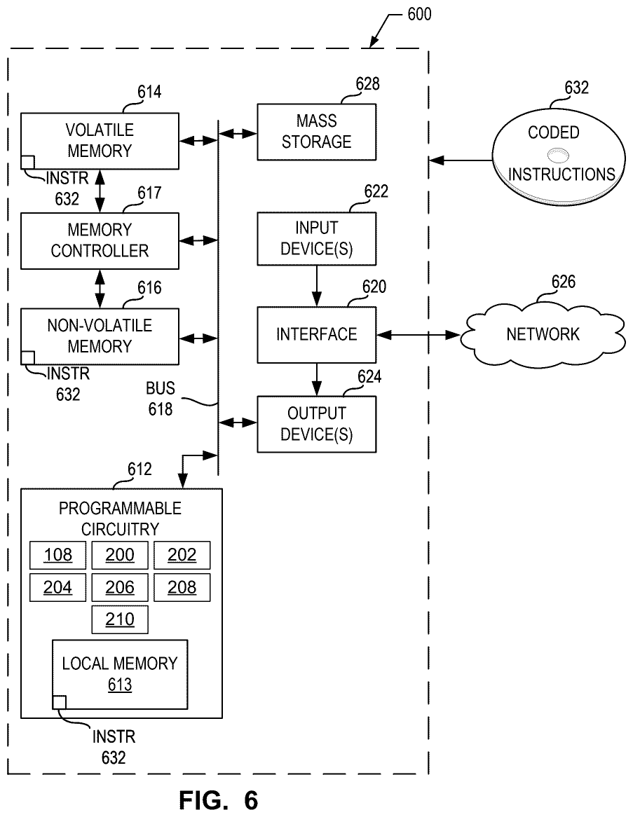

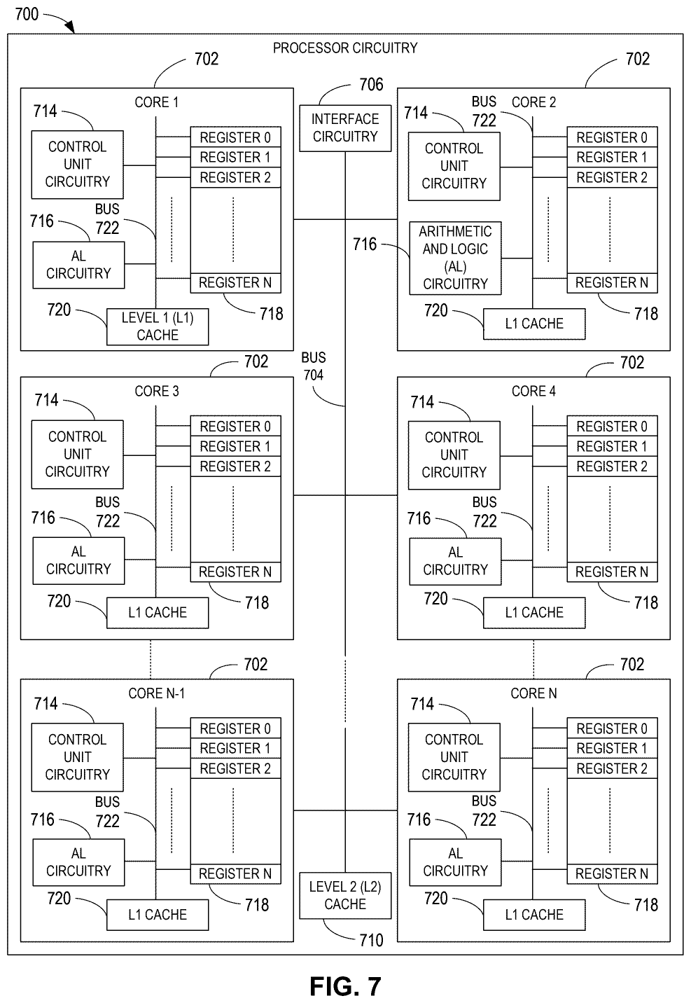

Flowchart(s) representative of example machine readable instructions, which may be executed by programmable circuitry to implement and/or instantiate the training data filtering circuitry 104 and/or the AI-based model training circuitry 108 of FIGS. 1 and/or 2 and/or representative of example operations which may be performed by programmable circuitry to implement and/or instantiate the training data filtering circuitry 104 and/or the AI-based model training circuitry 108 of FIGS. 1 and/or 2, are shown in FIGS. 3-4. The machine readable instructions may be one or more executable programs or portion(s) of one or more executable programs for execution by programmable circuitry such as the programmable circuitry 612 shown in the example processor platform 600 discussed below in connection with FIG. 6 and/or may be one or more function(s) or portion(s) of functions to be performed by the example programmable circuitry (e.g., an FPGA) discussed below in connection with FIGS. 7 and/or 8. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3-4, many other methods of implementing the example the training data filtering circuitry 104 and/or the AI-based model training circuitry 108 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-4 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a flowchart representative of example machine readable instructions and/or example operations 300 that may be executed, instantiated, and/or performed by programmable circuitry to process and/or filter training data for training an AI-based model. The example machine-readable instructions and/or the example operations 300 of FIG. 3 begin at block 302, at which the component interface circuitry 200 obtains the samples from the data training data storage 106 of FIG. 1. As described above, the training data includes labeled and/or non-labeled data that can be used to train an AI-based model.

At block 304, the transformation circuitry 202 transforms the samples into an inference ready state. As further described above, the transformation circuitry 202 can clean, combine, tokenize, and/or vectorize the obtained samples. At block 306, the signature generation circuitry 204 performs a Minhash signature generation for the transformed samples. In some examples, the signature generation circuitry 204 can perform a different hash generation protocol to the transformed samples. As described above, the signature generation circuitry 204 can generate one or more hash signatures for each of the transformed samples. At block 308, the clustering circuitry 206 generates similarity clusters by grouping samples based on the Minhash signatures. As further described above, the clustering circuitry 206 may generate the clusters using a k-modes clustering model. Additionally, the clustering circuitry 206 can generate statistics related to the clusters (e.g., a number of samples per cluster, a percentage of labeled samples in a cluster, a percentage of samples in each cluster that correspond to a classification and/or label, etc.).

At block 310, the clustering circuitry 206 determines if there is a cluster with less than a threshold number or percentage of unlabeled data. If the clustering circuitry 206 determines that there is not a cluster with less than a threshold number of labeled data (block 310: NO), control continues to block 314. If the clustering circuitry 206 determines that there is at least one cluster with less than a threshold number of labeled data (block 310: YES), the sample expansion circuitry 210 triggers the unlabeled samples of the cluster for labeling (e.g., by a human or a computing device) (block 312). In this manner, the sample expansion circuitry 210 can identify where labelling is needed and trigger the labelling to increase the database with labeling where it is most needed.

At block 314, the clustering circuitry 206 determines if more than a threshold percentage of the labeled samples in a cluster correspond to a particular label. For example, the clustering circuitry 206 can determine if more than 99% of the labeled samples in a cluster correspond to a malicious file. If the clustering circuitry 206 determines that more than a threshold percentage of the labeled samples in the cluster do not correspond to a particular label (block 314: NO), control continues to block 318. If the clustering circuitry 206 determines that more than a threshold percentage of the labeled samples in the cluster correspond to a particular label (block 314: YES), the sample expansion circuitry 210 labels the unlabeled samples in the cluster with the same label as the labeled samples in the cluster (block 316). For example, if more than 99% of the labeled samples in a cluster correspond to a malicious file, the sample expansion circuitry 210 labels the unlabeled samples of the cluster as also malicious.

At block 318, the filtering circuitry 208 filters the sample based on the clusters and/or the cluster statistics. Although there are many different ways to filter the training data based on the clusters and/or statistics, a particular way to filter the samples is further described below in conjunction with FIG. 4. At block 320, the AI-based model training circuitry 108 trains the AI-based model based on the filtered samples. Because the samples were filtered to avoid over and/or underrepresentation of files, the AI-based model training circuitry 108 can train the AI-based model effectively using less resources and time than using all the samples from the training data storage 106 of FIG. 1. At block 322, the interface circuitry 110 of FIG. 1 deploys the trained AI-based model. For example, the interface circuitry 110 can transmit information related to weights, thresholds, structure of the AI-based model (e.g., number or neurons, number of layers, number of neurons per layer, etc.).

FIG. 4 is a flowchart representative of example machine readable instructions and/or example operations 400 that may be executed, instantiated, and/or performed by programmable circuitry to filter samples based on clusters and/or corresponding statistics. The example machine-readable instructions and/or the example operations 400 of FIG. 4 begin at block 402, at which the filtering circuitry 208 identifies the cluster with the least number of samples.

At block 404, the filtering circuitry 208 multiplies the identified number by a factor to generate a maximum. For example, if the cluster with the least number of samples includes 10,000 samples and the factor is 110%, then the filtering circuitry 208 determines that the maximum is 11,000 (e.g., 10,000*1.1). The factor may be based on user and/or manufacturer preferences. At block 406, the filtering circuitry 208 selects a cluster from the set of clusters. At block 408, the filtering circuitry 208 determines if the number of samples in the selected cluster is greater than the maximum.

If the filtering circuitry 208 determines that the number of samples in the cluster is not greater than the maximum (block 408: NO), control continues to block 412. If the filtering circuitry 208 determines that the number of samples in the cluster is greater than the maximum (block 408: YES), the filtering circuitry 208 filters out samples from the cluster to reduce the number of samples to the maximum (block 410). Additionally, the filtering circuitry 208 can determine which samples to filter out within the cluster based on the current samples in the filtered dataset. For example, if a user desires a dataset with a particular threshold range corresponding to a particular label, the filtering circuitry 208 can filter out samples that correspond to the particular label if the percentage of samples in the filtered data set is too high.

At block 412, the filtering circuitry 208 determines if there is an additional cluster in the dataset to process. If the filtering circuitry 208 determines that there is an additional cluster to process (block 412: YES), control returns to block 406. If the filtering circuitry 208 determines that there is not an additional cluster to process (block 412: NO), the instructions end.

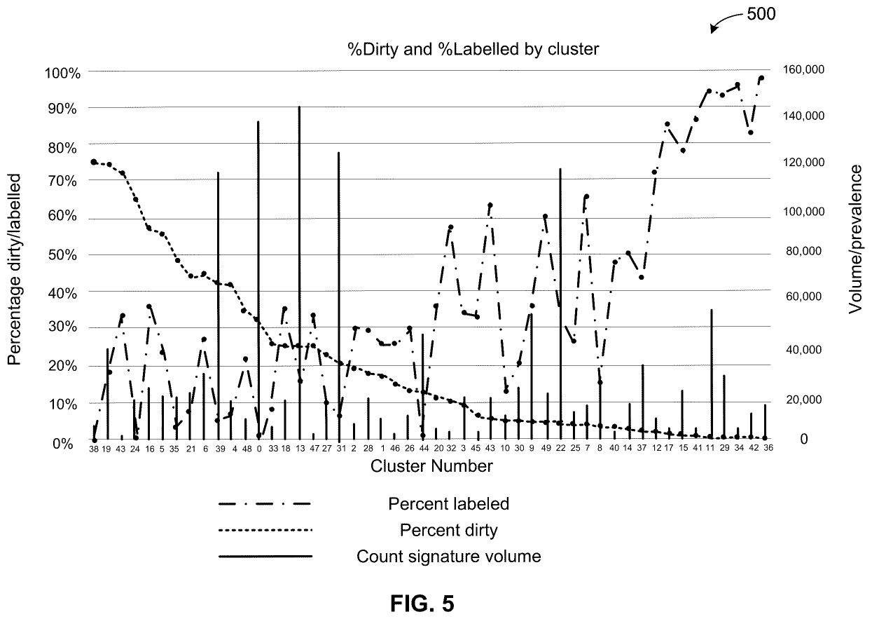

FIG. 5 illustrates an example graph 500 representative of cluster statistics that can be generated by the training data filtering circuitry of FIG. 2 based on an example dataset. The graph 500 illustrates cluster statistics including cluster identifies, the number of files for each cluster, the percentage of files that are labelled within the different clusters, and the percentage of malicious files within the different clusters. As described above, the training data filtering circuitry 104 can use the information generated and illustrated in the graph to filter the dataset (e.g., filter out files from the clusters with the highest number of files), trigger steps to increase the number of labels for files of a particular cluster, and/or label unlabeled data for files within a cluster. For example, because clusters 11, 29, 34, 42, and 36 have very low percentages of malicious labels, the training data filtering circuitry 104 may label the unlabeled files within clusters 11, 29, 34, 42, and 36 as non-malicious. Additionally, because clusters 0 and 44 have a low percentage of labeled files, the training data filtering circuitry 104 may trigger samples from those clusters to be labelled.

FIG. 6 is a block diagram of an example programmable circuitry platform 600 structured to execute and/or instantiate the example machine-readable instructions and/or the example operations of FIGS. 3-4 to implement the training data filtering circuitry 104 and/or the AI-based model training circuitry 108 of FIGS. 1 and/or 2. The programmable circuitry platform 600 can be, for example, a server, a personal computer, a workstation, a self-learning machine (e.g., a neural network), a mobile device (e.g., a cell phone, a smart phone, a tablet such as an iPad™), or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the AI-based model training circuitry 108, the component interface circuitry 200, the transformation circuitry 202, the signature generation circuitry 204, the clustering circuitry 206, the filtering circuitry 208, and the sample expansion circuitry 210 of FIGS. 1 and 2.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, and/or a speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIGS. 3-4, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowcharts of FIGS. 3-4 to effectively instantiate the circuitry of FIG. 2 as logic circuits to perform operations corresponding to those machine readable instructions. In some such examples, the circuitry of FIGS. 1 and/or 2 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 3-4.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7.

Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

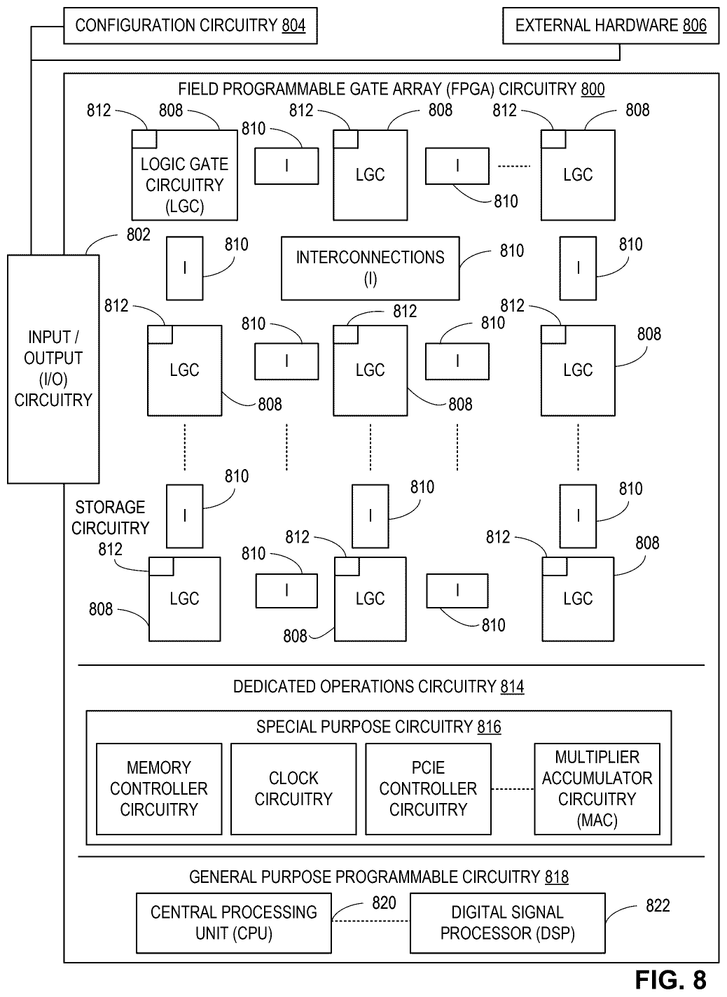

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine readable instructions represented by the flowchart(s) of FIGS. 3-4 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3-4. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3-4. As such, the FPGA circuitry 800 may be configured and/or structured to effectively instantiate some or all of the operations/functions corresponding to the machine readable instructions of the flowchart(s) of FIGS. 3-4 as dedicated logic circuits to perform the operations/functions corresponding to those software instructions in a dedicated manner analogous to an ASIC. Therefore, the FPGA circuitry 800 may perform the operations/functions corresponding to the some or all of the machine readable instructions of FIGS. 3-4 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain a binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine readable instructions of FIGS. 3-4 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 may execute a first portion of the machine readable instructions represented by the flowchart(s) of FIGS. 3-4 to perform first operation(s)/function(s), the FPGA circuitry 800 of FIG. 8 may be configured and/or structured to perform second operation(s)/function(s) corresponding to a second portion of the machine readable instructions represented by the flowcharts of FIG. 3-4, and/or an ASIC may be configured and/or structured to perform third operation(s)/function(s) corresponding to a third portion of the machine readable instructions represented by the flowcharts of FIGS. 3-4.

It should be understood that some or all of the circuitry of FIGS. 1 and/or 2 may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry of FIGS. 1 and/or 2 may be instantiated, for example, in one or more threads executing concurrently and/or in series. For example, the microprocessor 700 of FIG. 7 may execute machine readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of FIGS. 1 and/or 2 may be implemented within one or more virtual machines and/or containers executing on the microprocessor 700 of FIG. 7.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

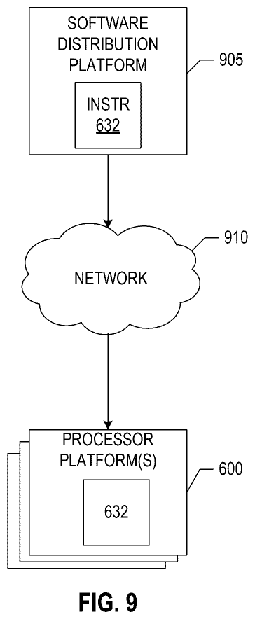

A block diagram illustrating an example software distribution platform 905 to distribute software such as the example machine readable instructions 632 of FIG. 6 to other hardware devices (e.g., hardware devices owned and/or operated by third parties from the owner and/or operator of the software distribution platform) is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions of FIGS. 3-4, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions of FIG. 3-4, may be downloaded to the example programmable circuitry platform 600, which is to execute the machine readable instructions 632 to implement the training data filtering circuitry 104 and/or the AI-based model training circuitry 108. In some examples, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that processes training data for an AI-based model. Disclosed systems, apparatus, articles of manufacture, and methods improve the efficiency of a computing device by reducing the amount of training data that is used to train an AI-based model to reduce the time and/or resources needed to train with a full dataset. Additionally, examples disclosed herein perform a filtering protocol to ensure that data is not underrepresented or overrepresented. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to process training data for an AI-based model are disclosed herein. Further examples and combinations thereof include the following: Example 1 includes an apparatus comprising interface circuitry to obtain data samples to train an AI-based model, machine readable instructions, and at least one programmable circuit to at least one of instantiate or execute the machine readable instructions to transform the data samples into features, generate hash signatures for corresponding ones of the features, group the features into clusters based on the hash signatures, generate a filtered data set by filtering out features within a cluster of features having more than a threshold number of features, and train the AI-based model based on the filtered data set.

Example 2 includes the apparatus of example 1, wherein one or more of the at least one programmable circuit is to generate the hash signatures using a Minhash signature generation technique.

Example 3 includes the apparatus of any one of examples 1-2, wherein one or more of the at least one programmable circuit is to group the features into the clusters using a k-modes clustering model.

Example 4 includes the apparatus of any one of examples 1-3, wherein the data samples include labeled and unlabeled samples.

Example 5 includes the apparatus of any one of examples 1-4, wherein the data samples include benign files and malicious files.

Example 6 includes the apparatus of any one of examples 1-5, wherein one or more of the at least one programmable circuit is to label unlabeled samples in the cluster based on labeled samples in the cluster.

Example 7 includes the apparatus of example 6, wherein one or more of the at least one programmable circuit is to label the unlabeled samples in the cluster responsive to more than a threshold percentage of the labeled samples in the cluster corresponding to a same label.

Example 8 includes the apparatus of any one of examples 1-7, wherein the cluster is a first cluster, the one or more of the at least one programmable circuit to determine that a second cluster has less than a threshold number of labeled samples, and trigger generation of labels for unlabeled samples in the second cluster.

Example 9 includes the apparatus of example 8, wherein one or more of the at least one programmable circuit is to trigger the generation of the labels for the unlabeled samples in the cluster by requesting information from a device that corresponds to the sample.

Example 10 includes a non-transitory computer readable medium comprising instructions to cause at least one programmable circuit to generate hash signatures for corresponding data samples, group the data samples into clusters based on the hash signatures, generate a filtered data set by filtering out data samples within a cluster of data samples having more than a threshold number of data samples, and train an AI-based model based on the filtered data set.

Example 11 includes the non-transitory computer readable storage medium of example 10, wherein the instructions cause one or more of the at least one programmable circuit to generate the hash signatures based on a Minhash signature generation technique.

Example 12 includes the non-transitory computer readable storage medium of any one of examples 10-11, wherein the instructions cause one or more of the at least one programmable circuit to group the data samples into the clusters using a k-modes clustering model.

Example 13 includes the non-transitory computer readable storage medium of any one of examples 10-12, wherein the data samples include labeled and unlabeled samples.

Example 14 includes the non-transitory computer readable storage medium of any one of examples 10-13, wherein the data samples include benign files and malicious files.

Example 15 includes the non-transitory computer readable storage medium of any one of examples 10-14, wherein the instructions cause one or more of the at least one programmable circuit to label unlabeled samples in the first cluster based on labeled samples in the cluster.

Example 16 includes the non-transitory computer readable storage medium of example 15, wherein the instructions cause one or more of the at least one programmable circuit to label the unlabeled samples in the cluster responsive to more than a threshold percentage of the labeled samples in the cluster corresponding to a same label.

Example 17 includes the non-transitory computer readable storage medium of any one of examples 10-16, wherein the cluster is a first cluster, the instructions to cause one or more of the at least one programmable circuit to determine that a second cluster has less than a threshold number of labeled samples, and trigger generation of labels for unlabeled samples in the second cluster.

Example 18 includes the non-transitory computer readable storage medium of example 17, wherein the instructions cause one or more of the at least one programmable circuit to trigger the generation of the labels for the unlabeled samples in the cluster by requesting information from a device that corresponds to the sample.

Example 19 includes a method comprising

transforming, by executing an instruction with programmable circuitry, data samples into features, generating, by executing an instruction with the programmable circuitry, hash signatures for corresponding ones of the features, grouping, by executing an instruction with the programmable circuitry, the features into clusters based on the hash signatures, generating, by executing an instruction with the programmable circuitry, a filtered data set by filtering out features within a cluster of features having more than a threshold number of features, and training, by executing an instruction with the programmable circuitry, an AI-based model based on the filtered data set.

Example 20 includes the method of example 19, wherein the generating of the hash signatures includes using a Minhash signature generation technique, and the grouping of the features into the clusters includes using a k-modes clustering model.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry to obtain data samples to train an AI-based model;
machine readable instructions; and
at least one programmable circuit to at least one of instantiate or execute the machine readable instructions to:
transform the data samples into features;
generate hash signatures for corresponding ones of the features;
group the features into clusters based on the hash signatures;
generate a filtered data set by filtering out features within a cluster of features having more than a threshold number of features; and
train the AI-based model based on the filtered data set.

2. The apparatus of claim 1, wherein one or more of the at least one programmable circuit is to generate the hash signatures using a Minhash signature generation technique.

3. The apparatus of claim 1, wherein one or more of the at least one programmable circuit is to group the features into the clusters using a k-modes clustering model.

4. The apparatus of claim 1, wherein the data samples include labeled and unlabeled samples.

5. The apparatus of claim 1, wherein the data samples include benign files and malicious files.

6. The apparatus of claim 1, wherein one or more of the at least one programmable circuit is to label unlabeled samples in the cluster based on labeled samples in the cluster.

7. The apparatus of claim 6, wherein one or more of the at least one programmable circuit is to label the unlabeled samples in the cluster responsive to more than a threshold percentage of the labeled samples in the cluster corresponding to a same label.

8. The apparatus of claim 1, wherein the cluster is a first cluster, the one or more of the at least one programmable circuit to:
determine that a second cluster has less than a threshold number of labeled samples; and
trigger generation of labels for unlabeled samples in the second cluster.

9. The apparatus of claim 8, wherein one or more of the at least one programmable circuit is to trigger the generation of the labels for the unlabeled samples in the cluster by requesting information from a device that corresponds to the sample.

10. A non-transitory computer readable medium comprising instructions to cause at least one programmable circuit to:
generate hash signatures for corresponding data samples;
group the data samples into clusters based on the hash signatures;
generate a filtered data set by filtering out data samples within a cluster of data samples having more than a threshold number of data samples; and
train an AI-based model based on the filtered data set.

11. The non-transitory computer readable storage medium of claim 10, wherein the instructions cause one or more of the at least one programmable circuit to generate the hash signatures based on a Minhash signature generation technique.

12. The non-transitory computer readable storage medium of claim 10, wherein the instructions cause one or more of the at least one programmable circuit to group the data samples into the clusters using a k-modes clustering model.

13. The non-transitory computer readable storage medium of claim 10, wherein the data samples include labeled and unlabeled samples.

14. The non-transitory computer readable storage medium of claim 10, wherein the data samples include benign files and malicious files.

15. The non-transitory computer readable storage medium of claim 10, wherein the instructions cause one or more of the at least one programmable circuit to label unlabeled samples in the first cluster based on labeled samples in the cluster.

16. The non-transitory computer readable storage medium of claim 15, wherein the instructions cause one or more of the at least one programmable circuit to label the unlabeled samples in the cluster responsive to more than a threshold percentage of the labeled samples in the cluster corresponding to a same label.

17. The non-transitory computer readable storage medium of claim 10, wherein the cluster is a first cluster, the instructions to cause one or more of the at least one programmable circuit to:
determine that a second cluster has less than a threshold number of labeled samples; and
trigger generation of labels for unlabeled samples in the second cluster.

18. The non-transitory computer readable storage medium of claim 17, wherein the instructions cause one or more of the at least one programmable circuit to trigger the generation of the labels for the unlabeled samples in the cluster by requesting information from a device that corresponds to the sample.

19. A method comprising:
transforming, by executing an instruction with programmable circuitry, data samples into features;
generating, by executing an instruction with the programmable circuitry, hash signatures for corresponding ones of the features;
grouping, by executing an instruction with the programmable circuitry, the features into clusters based on the hash signatures;
generating, by executing an instruction with the programmable circuitry, a filtered data set by filtering out features within a cluster of features having more than a threshold number of features; and
training, by executing an instruction with the programmable circuitry, an AI-based model based on the filtered data set.

20. The method of claim 19, wherein:
the generating of the hash signatures includes using a Minhash signature generation technique; and
the grouping of the features into the clusters includes using a k-modes clustering model.
